(19) United States
(12) Patent Application Publication
(10) Pub. No.: US 2015/0267820 A1
(43) Pub. Date: Sep. 24, 2015

(54) Control valve for adjusting a flow rate value

(71) Applicant: SAMSON AG, FRANKFURT AM MAIN (DE)

(72) Inventor: JORG KIESBAUER, EPPERTSHAUSEN (DE)

(73) Assignee: SAMSON AG, FRANKFURT AM MAIN (DE)

(21) Appl. No.: 14/664,384

(22) Filed: Mar. 20, 2015

(30) Foreign Application Priority Data
Mar. 21, 2014 (DE) 10 2014 103 902.5

(51) Int. Cl. F16K 3/316; F16K 3/02; F16K 31/12; F16K 3/32

(52) U.S. Cl. CPC F16K 3/316; F16K 3/32; F16K 3/02; F16K 31/12

(57) ABSTRACT

The invention relates to a control valve (10, 30) for adjusting a flow rate value of said control valve, comprising a valve housing (12) as well as a housing-mounted throttling structure (14, 34, 52) which covers a flow channel and includes at least two passages (16, 36, 54), furthermore a second closing structure (18, 40, 56) which can be moved relative to the housing-mounted throttling structure (14, 34, 52), which closing structure (18, 40, 56) can be moved so as to close the passages (16, 36, 54) in such a way that the flow rate through the passages covered by the closing structure is lower than the flow rate through the uncovered passages (16, 36, 54). The invention is characterized in that guide means (22, 44) are arranged outside a passage area of the housing-mounted throttling structure (14, 34, 54) defined by passages (16, 36, 52), said guide means (22, 44) acting to support and guide the movable closing structure (18, 40, 56) spaced from the housing-mounted throttling structure (14, 34, 52).

The invention relates to a control valve for adjusting the flow rate value of the control valve.

Document DE 10 2008 000 735 83 relates to a valve comprising a resistance structure, with a first resistance plate and a second movable resistance plate. The movable closing structure is guided—relative to the housing-mounted throttling structure—such that any change in position of the movable closing structure will result in a change of the flow resistance.

The closing structure of DE 10 2008 000 735 83 is guided directly via the second housing-mounted throttling structure, said movement causing friction between the closing structure and the valve plate.

In order to reduce any friction occurring between the valve plates, document DE 83 31183 U1 suggests that a spring should be provided between the housing-mounted structure and the movable closing structure in the area of the passage so as to space the valve plates from each other. This will considerably diminish any friction caused by the relative movement of the valve plates. However, positioning the spring in the area of the passages of the valve plate will affect the flow.

It is the object of the invention to provide a largely friction-free valve structure which will not affect the flow in the area of the passage.

In a known manner, a control valve for controlling the volume flow of a medium comprises a housing as well as a housing-mounted throttling structure with passages provided therein, said throttling structure essentially covering a passageway. These passages, which in their entirety form a passage area, define a maximum flow rate value. The control valve furthermore comprises a second closing structure which can be moved relative to the housing-mounted throttling structure. This movable closing structure can be used to cover at least certain regions of the passages of the throttling structure, with the movement of the closing structure allowing the passages to be covered such that the flow through the passages covered by the closing structure is lower than the flow through passages which are not covered. This largely prevents the medium from flowing through the covered passages, the overall result being a reduction in the flow rate value.

According to the invention, guide means are provided outside the passages and/or outside the passage area of the housing-mounted throttling structure, said guide means acting to guide the movable closing structure and keep it spaced from the housing-mounted throttling structure. This thus locates and guides the movable closing structure at a predefined distance from the housing-mounted throttling structure. Such distance is preferably chosen to be as small as possible.

This will ensure low-friction operation of the control valve without affecting the flow through the passage area. This in turn results in less force being required for operating the control valve.

Notably, the control valve is designed as a slide valve, with the closing structure essentially moving in parallel to the housing-mounted throttling structure.

In an advantageous embodiment of the invention, an actuator is provided for a translational movement of the movable closing structure.

Said actuator is guided within the housing, and said guide means notably cooperate with the actuator so as to guide the movable closing structure spaced from the housing-mounted throttling structure. To this end, the guide means are mounted within said housing and thus outside the area of the passages.

In yet another advantageous embodiment, the movable closing structure may also be supported so as to be rotatable relative to the housing-mounted throttling structure. Rotatably supporting the closing structure allows the effective passage area to be adjusted via the rotation angle of the movable closing structure relative to the housing-mounted throttling structure. This rotary principle makes it possible to use a particularly small design as the movement will not extend to beyond the passage area.

Preferably a sealing structure may be provided, in particular on the housing-mounted throttling structure outside the passage area, said sealing structure sealing the movable closing structure in such a closed position, thus preventing the medium from flowing through the passageway.

Advantageously, the guide means may also be designed as a seal which frames the passages and/or the passage area, in particular on the housing-mounted throttling structure. This yields the advantage that the movable closing structure can be guided with low friction and the structure can be sealed in its closed position.

Furthermore, the control valve can be of a design in which the movable closing structure and the housing-mounted throttling structure do not exhibit any passages in an area shaped like the segment of a circle. In this way, if a closing structure is used which can be rotated, the effective passage area can be adjusted via the angle of rotation of the movable closing structure relative to the housing-mounted throttling structure.

In accordance with an advantageous embodiment, the throttling structure and/or the closing structure may be of a plate-like design. This is a particularly simple way of implementing the invention.

Advantageously, the guide means are designed so as to absorb the contact pressure exerted on the actuator by the medium. This ensures that the movable closing structure can be moved without tilting.

Additional advantages, features and possible applications of the present invention may be gathered from the description which follows in which reference is made to the embodiments illustrated in the drawings.

Throughout the description, the claims and the drawings, those terms and associated reference signs will be used as are notable from the enclosed list of reference signs. In the drawings

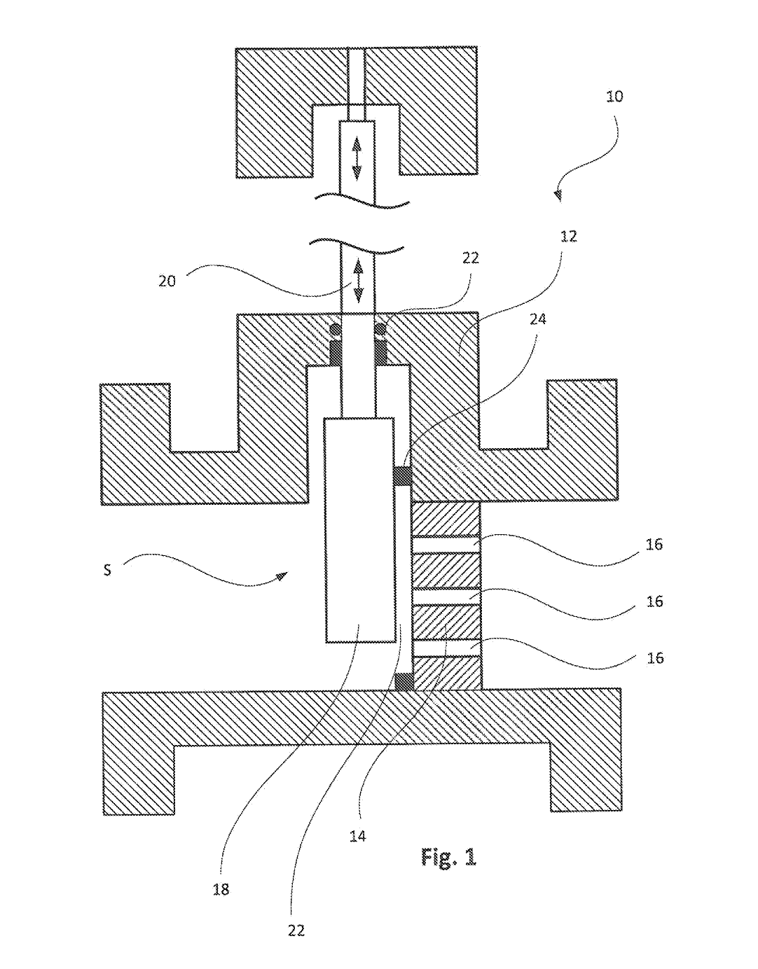

FIG. 1 is a view of a slide valve according to the invention, in an open position thereof;

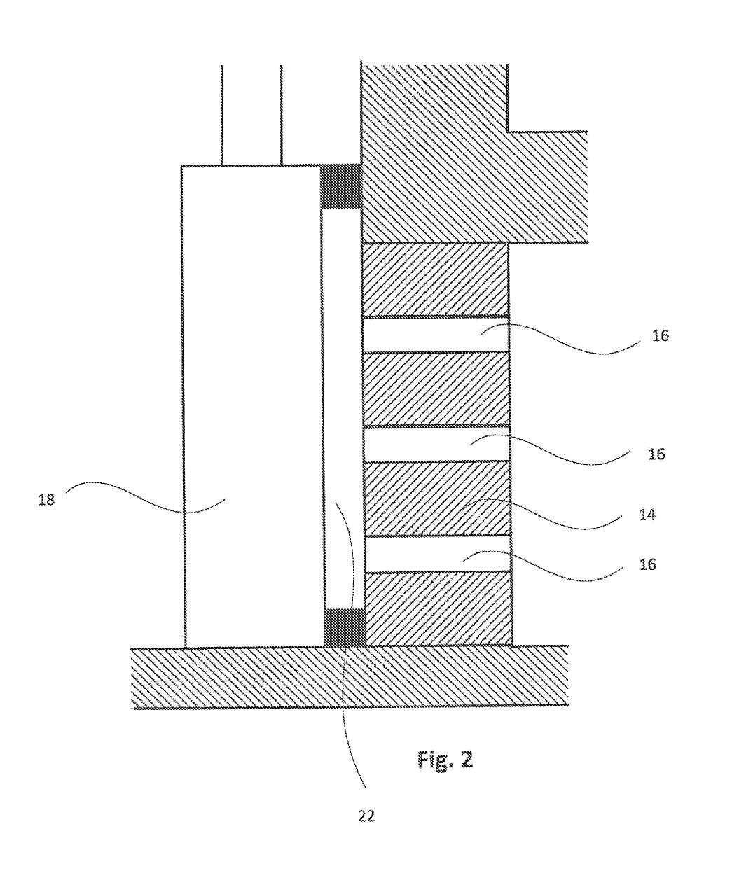

FIG. 2 is a view of a translational slide valve according to the invention, in a closed position thereof;

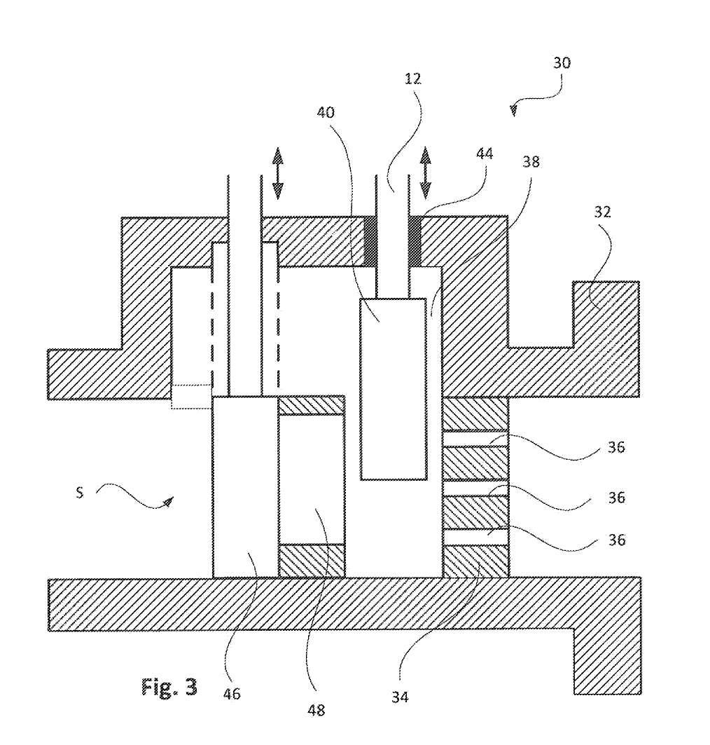

FIG. 3 is a view of a valve arrangement according to the invention comprising a slide valve according to the invention in an open position thereof and a closing valve in a closed position thereof;

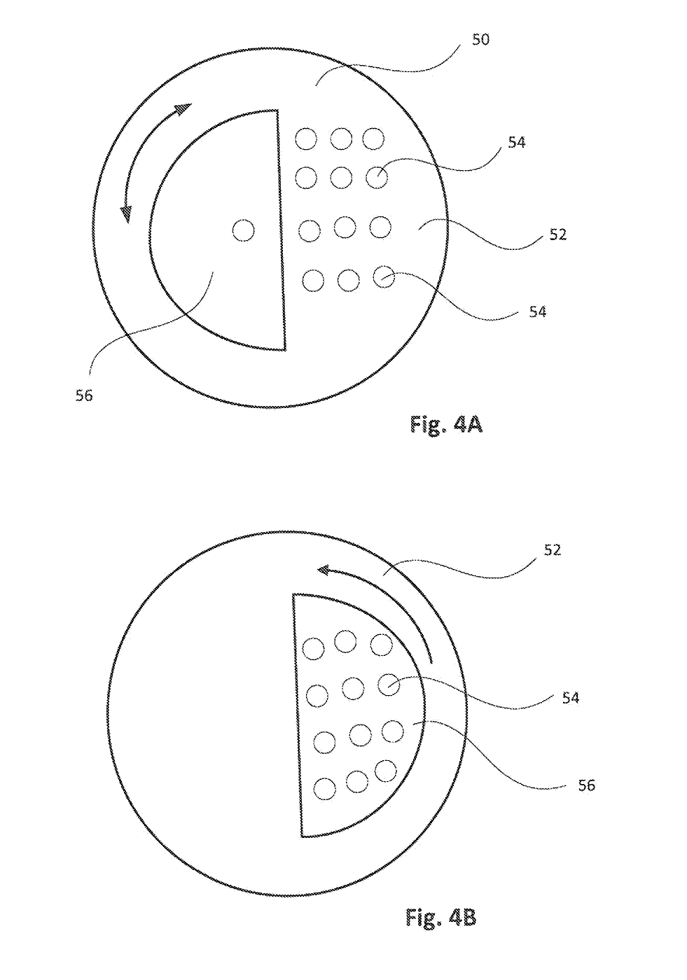

FIG. 4a is a view of a rotational slide valve, in an open position thereof, and

FIG. 4b is a view of a rotational slide valve, in a closed position thereof.

Shown in FIG. 1 is a translational slide valve 10 according to the invention, comprising a valve housing 12 having a housing-mounted throttling structure 14 with passages 16 extending therethrough. The passages 16 define a maximum flow rate value. All the passages taken together form a passage area, in particular in the shape of a segment of a circle. Depending on the valve position of the movable closing structure 18, these passages 16 will be covered, which thus allows the flow rate value to be varied. For this purpose, the closing structure 18, which can be translation ally moved, is connected to an actuator 20 which is supported in guide means 22 to ensure that the actuator 20 will guide the movable closing structure 18 such that it is spaced by a gap 22. In addition, outside the area of the passage structures 16, a sealing frame 24 is provided which will completely seal the passage area when the movable closing structure 18 is in its closed position.

It is to be noted that the movable closing structure 18 is arranged upstream of the housing-mounted throttling structure 14. It is indicated at the distal end of the actuator 20 relative to the movable closing structure 18 that movement of the actuator 20 by the medium to be controlled may be effected hydraulically.

As an alternative, the movable closing structure 18 can also be moved from the outside, mechanically, translationally.

FIG. 2 is an enlarged detail of the slide valve of FIG. 1 in its closed position. This view of FIG. 2 shows quite clearly that the all-round sealing frame 24 completely prevents medium from flowing through the housing-mounted throttling structure 14.

FIG. 3 is a slide valve 30 which—depending on the overlap area—has a housing 32 containing a housing-mounted throttling structure 34 with passages 36 provided therein. Spaced therefrom by a gap 28 is a movable closing structure 40 which is arranged such that it can be actuated via an actuator 42. Movement of the closing structure 40 allows an adjustment of the flow rate value of the movable closing structure and the passage areas. Mounted on the valve housing outside the passage area and engaging the actuator are guide means 44 which act to keep the movable closing structure 40 spaced from the housing-mounted throttling structure 34. As a result, the movable closing structure 40 can be displaced without any friction. For this reason, a smaller amount of drive energy is required. This embodiment uses a second actuator 46 which can be translationally moved so as to close a flow channel 48 and thus prevent the flow of medium therethrough. In the open position of the movable closing structure 46, the flow rate of the slide valve 30 can be varied by the second movable closing structure 40. Friction-free control can thus be achieved, at the same time ensuring reliable sealing of the valve if required.

FIG. 4a is a view of a rotary slide valve element 50 comprising a housing-mounted throttling structure 52 with passages 54 extending therethrough. Located opposite said housing-mounted throttling structure 52 is a valve plate 56 in the shape of a half disc which can be rotated relative to the housing-mounted throttling structure 52. In the mode of operation of FIG. 4a, the passages will allow a flow of the medium to be controlled therethrough. As viewed in the flow direction, the movable closing structure 56 is also arranged so as to be spaced from the housing-mounted throttling structure 52 in order to allow a friction-free movement of the movable closing structure 56.

FIG. 4b is a view of the arrangement of FIG. 4a in which the movable closing structure 56 covers the passages 54 of the housing-mounted throttling structure 52 which are still indicated in this drawing. This largely prevents the medium from flowing through these passages.

### LIST OF REFERENCE SIGNS

10 slide valve
12 valve housing
14 housing-mounted throttling structure
16 passages
18 movable closing structure
20 actuator
22 guide means, gap
24 sealing frame
28 gap
30 slide valve
32 housing
34 housing-mounted throttling structure
36 passages
40 movable closing structure
42 actuator
44 guide means
46 movable actuator, movable closing structure
48 flow channel
50 rotary slide valve
52 housing-mounted throttling structure
54 passages
56 movable closing structure

1-10. (canceled)

11. A control valve (10, 30) for adjusting a flow rate value of said control valve, comprising:
a valve housing (12);
said valve housing includes a valve housing-mounted throttling structure (14, 34, 52), said valve housing-mounted throttling structure covers a flow channel and includes at least two passages (16, 36, 54);
a second movable closing structure (18, 40, 56), said second movable closing structure is movable relative to said housing-mounted throttling structure (14, 34, 52);
said second movable closing structure (18, 40, 56) is movable to close said passages (16, 36, 54) such that the flow rate through said passages covered by said closing structure is lower than the flow rate through said uncovered passages (16, 36, 54);
guide means (22, 44) are arranged outside a passage area defined by said passages (16, 36, 52) of said housing-mounted throttling structure (14, 34, 54);
said guide means (22, 44) act to support and guide said movable closing structure (18, 40, 56) spaced from said housing-mounted throttling structure (14, 34, 52).

12. The control valve as claimed in claim 11, further comprising:
said movable closing structure (18, 40, 56) is supported so as to allow a translational movement thereof with respect to said housing-mounted throttling structure (14, 34, 52).

13. The control valve as claimed in claim 12, further comprising:
an actuator (20, 42, 46);
said actuator is provided for a translational movement of said movable closing structure (18, 40, 56), said actuator (20, 42, 46) being guided within said housing , and said guide means (22, 44) cooperating with said actuator (20, 42, 46) so as to guide said movable closing structure spaced from said housing-mounted throttling structure.

14. The control valve as claimed in claim 11, further comprising:
said movable closing structure (18, 40, 56) is mounted so as to be rotatable with respect to said housing-mounted throttling structure.

15. The control valve as claimed in claim 11, further comprising:
a sealing structure, said sealing structure seals said movable closing structure (18, 40, 56) in closed position, thus preventing a flow of a medium therethrough.

16. The control valve as claimed in claim 15, further comprising:
said guide means form a seal which seals a passage area defined by said passages (16, 36, 54).

17. The control valve as claimed in claim 13, further comprising:
said movable structure and said housing-mounted throttling structure (14, 34, 52) each have an area in the form of a segment of a circle in which there are no passages (16, 36, 54).

18. The control valve as claimed in claim 13, further comprising:
said guide means are designed so as to absorb the contact pressure exerted on said actuator (20, 42, 46) by a medium.

19. The control valve as claimed in claim 13, further comprising:
a medium impinging on said actuator will result in a hydraulic displacement of said movable closing structure (18).

20. The control valve as claimed in claim 11 wherein said control valve is designed as a slide valve.
